(19) United States
(12) Patent Application Publication
(10) Pub. No.: US 2008/0077440 A1
(43) Pub. Date: Mar. 27, 2008

(54) DRUG DISPENSER RESPONSIVE TO PHYSIOLOGICAL PARAMETERS

(75) Inventor: Eyal Doron, Kiriat-Yam (IL)

Correspondence Address: FAEGRE & BENSON, LLP;BOSTON SCIENTIFIC PATENT DOCK, 2200 WELLS FARGO CENTER, 90 SOUTH SEVENTH STREET, MINNEAPOLIS, MN, 55402-3901, US

(73) Assignee: Remon Medical Technologies, LTD, Caesarea (IL)

(21) Appl. No.: 11/860,498

(22) Filed: Sep. 24, 2007

Related U.S. Application Data
(60) Provisional application No. 60/826,948, filed on Sep. 26, 2006.

(51) Int. Cl. G06Q 50/00; G06F 17/00

(52) U.S. Cl. 705/2; 700/231

(57) ABSTRACT

An automatic drug dispensing system that dispenses variable amounts or types of drugs to treat a particular medical condition of a patient, the system comprising a medical sensor which may be implanted in or otherwise coupled to a body surface of a patient, wherein the sensor is configured to measure one or more physiological parameters of the patient; a user interface configured for receiving input relating to the patient's current condition; and a processor configured to determine one or more of a drug selection, dosage, and timing regime based at least in part on information received from the medical sensor and user interface.

### RELATED APPLICATION DATA

The present application claims the benefit under 35 U.S.C. § 119 to U.S. Provisional Patent Application Ser. No. 60/826,948 filed on Sep. 26, 2006. The foregoing application is incorporated by reference into the present application in its entirety for all purposes.

### FIELD OF INVENTION

This invention relates to the treatment of a chronic medical condition using drugs. Specifically, it relates to the modification of a drug regimen using physiological data from medical sensors. It also relates to the use of automated systems to optimize patient treatment.

### BACKGROUND

There are many chronic medical conditions which are treated by requiring a patient to take drugs for an extended period of time. For example, patients suffering from congestive heart failure (CHF) may be required to take an individually tailored, daily regimen of drugs, such as diuretics, blood thinners, angiotensin-converting enzyme (ACE) inhibitors, beta blockers, diuretics, and digoxin. Some CHF patients, especially ones suffering from additional co-morbidities, such as hypertension and diabetes, may be required to take ten or more pills a day, in a complicated regime tied to specific times and activities (e.g., following meals). This situation readily lends itself to patient confusion, and can result in dosing mistakes, which can be potentially dangerous to the patient.

To reduce the chances of such dosing mistakes, it has been suggested to use automatic drug dispensing systems. For example, U.S. Pat. No. 6,330,957 discloses an automatic medication dispenser, which can be pre-loaded with various drugs that a patient is supposed to take, and dispenses the drugs according to a predetermined daily (or weekly) schedule. Further drug management schemes based on “smart” drug dispensers are disclosed in U.S. Pat. Nos. 4,223,801, 4,768,176, 4,768,177, 5,200,891, 5,267,174, 5,329,459, 5,642,731, 5,752,235 and 5,954,641, 5,835,455, each of which describe devices configured to remind a patient to take his or her appropriate dosage of drugs according to various medication regimes and/or to monitor patient compliance.

A more sophisticated system is described in U.S. Pat. Nos. 6,471,645 and 6,824,512, which disclose and describe a drug dispenser in wireless communication with an implantable medical device (IMD), such as a pacemaker. The IMD logs the activity of the dispenser and correlates it with physiological measurements received by the IMD at the same time, such as ECG signals. The correlated dispenser and IMD data can be later viewed by a physician, e.g., via a remote link, to assist the physician in optimizing treatment of the patient.

A crucial point not addressed by the above-described systems is the timely modification of patient treatment corresponding to a changing progression of the disease. For example, a CHF patient might experience a decompensation event, wherein because of a change in a physiological parameter, the existing drug regime is no longer appropriate. Currently, the patient would likely contact his or her physician only at the onset of symptoms, in which case a degree of irreversible damage may already have occurred.

U.S. Pat. No. 6,970,742 (“the '742 patent”) discloses a system comprising an implantable sensor that measures a pressure indicative of the patient's left atrial blood pressure, wherein the sensor is in wireless communication with an external handheld interface and display unit. The handheld unit receives and processes the information from the sensor, and advises the patient on recommended (or required) changes in their medication regime. The '742 patent does not, however, describe or suggest a drug dispenser whose operation is dependent on data from the sensor, and so the danger of inadvertent dosing errors remains. The '742 patent also does not describe or suggest an algorithmic determination of a drug regimen, which can vary in response to input other than the haemodynamic sensor input.

### SUMMARY OF THE INVENTION

In one embodiment, the invention comprises an automatic drug dispensing system that dispenses variable amounts and/or types of drugs to treat a particular medical condition of a patient. The drug dispenser includes a medical sensor and/or is in constant or occasional communication with one or more medical sensors, each of which measure one or more physiological parameters of the patient. The drug dispensing system may also receive input from the patient relating to the patient's current condition via a user interface. The drug selection, dosage, and timing regime is controlled by a microprocessor based at least in part on information received from the sensors and/or the patient, according to one or more dispensing algorithms.

In addition, the dispenser may be in remote communication with a computer (server) situated at the location of a medical caregiver, such as a doctor's office, clinic, or hospital. The medical caregiver can thereby monitor the activities of the drug dispensing system, and can also modify the parameters controlling the activities of the system, such as the dispensing algorithm(s).

Such embodiments of the invention overcome shortcomings of the existing automated drug dispensing systems by using physiological sensor data and/or patient input to modify the medication regime according to a current state of the patient, thus providing ongoing optimization of the pharmacological treatment of chronic diseases, and preventing a drug imbalance from developing into a more serious situation.

In particular, such embodiments of the invention overcome shortcomings of the system described in the '742 patent, by providing an automated system that dispenses the correct medication according to current sensor readings. This takes the patient out of the therapeutic loop, and ensures the correct medication regime irrespective of patient confusion and error. In addition, embodiments of the invention include systems that can support a much more involved multi-drug medication regime that can be supported by the system described in the '742 patent, for example, which can depend on the fusion of several sensor and other inputs apart from just the implanted sensor.

Other aspects and embodiments of the present invention will become apparent from the following detailed description, taken in conjunction with the accompanying drawings.

### BRIEF DESCRIPTION OF THE DRAWINGS

Embodiments of the invention are illustrated by way of example and not limitation in the figures of the accompanying drawings, in which:

FIG. 1 is a schematic block diagram of one embodiment of a drug dispensing system according to the invention.

FIG. 2 is a schematic block diagram of another embodiment of the invention, including an indirect link set-up between a drug dispensing system (such as illustrated in FIG. 1) and an implanted medical sensor 124.

### DETAILED DESCRIPTION

Embodiments of the present invention are directed to a drug dispensing system which dispenses medicines to a patient according to a prescribed, and at least partially adaptive, medication regimen.

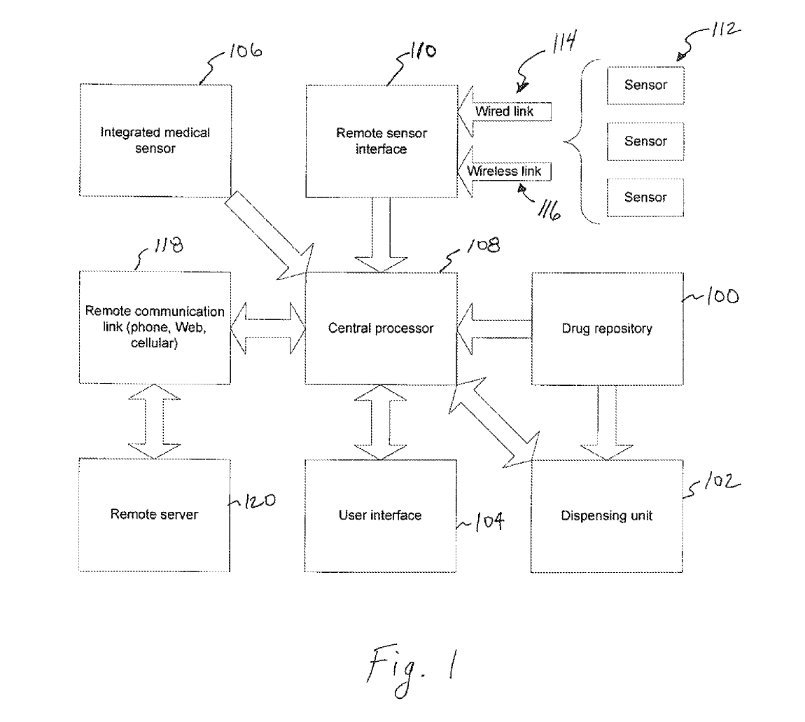

A schematic block diagram of an example embodiment of a dispensing system according to the is shown in FIG. 1. The components of the system are as follows:

Drug Repository

The system includes a drug repository 100, which preferably is preloaded with the appropriate drugs (both in kind and dosage), that are to be administered to the patient over a period of time. The drugs may be in the form of a liquid, a suspension, a powder, a gel, pills, capsules, ampules, sprays, transdermal patches, or any other drug delivery modality. The drugs may be uploaded into the repository in free form. Alternately, the drugs may be packaged in containers having means for automatic identification and characterization of content, such as text, barcodes, RFID tags, magnetic strips, magnetic ink, electronic chips, or any other suitable machine readable format.

The drug repository 100 may also contain means to determine an inventory of each kind and amount of drugs remaining therein. The amount may be determined by weight, color, shape, machine vision, electrical properties or any other measurement means. Alternatively, the amount remaining could be determined by keeping track of an amount dispensed.

The drug repository 100 may also include means to optimize the storage of the various drugs. Such means may include (but are not limited to) a cooling system, which may be manually or automatically (i.e., algorithmically) controlled together with identification of the specific drug. Other types of preservation means may be incorporated into the repository, such as (without limitation) airtight or light-tight enclosures, ventilation, use of an inert atmosphere, humidity control, periodic agitation of suspensions, ultraviolet irradiation, as well as any other type of drug storage and preservation means known in the art.

Dispensing Unit

The system further comprises a dispensing unit 102, which dispenses the drugs held in the drug repository 100 to the patient. Fully or partially mechanized drug dispensers are well known in the art, see for example U.S. Pat. Nos. 4,223,801, 5,267,174, 5,329,459, 5,835,455, 6,330,957, which are hereby incorporated in their entirety. By way of non-limiting example, a computerized drug dispensing system for home use is produced and sold by Unitech Co., Tokyo, Japan. By way of further, non-limiting example, a line of automatic and monitored dispensers of various capacities and functions is produced and distributed by E-pill LLC, of Wellesley, Mass.

The drug dispensing unit 102 may be manually actuated or mechanized (i.e., automated). As an example of a manually-actuated embodiment, the dispenser may comprise a variety of containers, each including a means to identify to the patient how many pills to take for a given dose. Such means could include, for example, an indicator light, a visual display, or an audio signal. A mechanized embodiment of the dispenser might include a mechanism for counting out a number of units of each kind of drug to take for a given dose, thus ensuring a correct dosage. In a semi-mechanized embodiment, the amount of a medication might appear on a display, but to decrease the chance of patient error, the respective containers could be locked for any drugs which are not to be taken for a particular dose.

User Interface

The system has a user interface (UI) 104, which operates in conjunction with an associated central processor 108. By way of example, the UI may alert the patient at a time when medications are to be taken. It may be the further task of the UI to indicate to the patient which type(s) of drugs are to be taken at that time. It may also be the task of the UI to indicate the amount of each type of drug to be taken. Such indications can be made by means of a visual display, or by means of indicator lights. Other possibilities include the use of audio signals, or by means of prerecorded or synthesized human speech.

In one embodiment, the UI incorporates a display that provides information and instructions in a graphic manner. Such a display may indicate the kinds and amounts of medication to take, the inventory status of the repository, and statistics, such as the amount consumed by (or at least dispensed to) that patient over various periods of time. The display may also give access to the input received from medical sensors in communication with the system, e.g., blood pressure, or heart rate. Additionally and/or alternatively, the display may indicate the patient's clinical status, as determined by the internal algorithms of the system. For example, if the patient is in the midst of a CHF decompensation event, this may be indicated on the display.

In one embodiment, the UI allows the patient to enter clinically relevant information. For example, the patient may indicate various symptoms he or she may have, such as fever, shortness of breath, fatigue, etc. By way of non-limiting example, the patient input may be prompted by the system, as determined by its internal algorithms. The data entry may be via a keyboard, touch screen, pushbuttons, pointing device, audio response, or any other data entry means known in the art.

The UI (alone or in conjunction with the central processor 108) may also contain a means to identify a patient. This can be for reasons of safety or security, or to enable a single dispensing system to serve more than one patient. Such identification may be performed by means of a password, magnetic card, smart card, RFID, cellular phone, or any other mobile identification means known in the art. Alternatively, the UI may contain means to perform biometric identification, such as by acquiring a fingerprint, voice recognition, face recognition, or some other biometric identification means known in the art. (See, for example, U.S. Pat. No. 6,961,448, “User authentication in medical device systems.”)

Integrated Medical Sensor

The drug dispensing system may incorporate an integrated medical sensor 106, which measures a parameter (e.g., blood pressure) indicative of a patient physiological condition. The integrated sensor 106 may be directly linked to the system's central processor 108 using internal electronics. Possible sensors for this application include, but are not limited to, electrical sensors such as ECG and EEG, pulse oximeters, bio-impedance sensor, body fluid assay devices, DNA chips, glucose meters, optical and infrared sensors, acoustic and audio sensors, chemical sensors, and many other medical sensors known in the art.

Remote Sensor Interface

The drug dispensing system may alternatively or additionally comprise a remote sensor interface 110, which interfaces with one or more remote medical sensors 112. The sensor interface 110 receive as inputs clinical and physiological data obtained from the remote sensor(s) 112 into the system's controller 108, which input(s) may be affect the patient's medication regime according to predetermined algorithms.

In one such embodiment, the system responds to sensors relating to heart failure. One such sensor is a digital scale. Another such sensor is an implantable haemodynamic sensor, such as those described in U.S. Pat. Nos. 5,368,040, 6,764,446, 6,855,115, 6,970,742. Another such sensor may be an implantable pulse generator, such as a pacemaker or defibrillator, which senses parameters such as temperature, ECG, acceleration, impedance (U.S. Pat. No. 6,411,850), lung sounds (U.S. Pat. No. 6,949,075), heart sounds (U.S. Pat. No. 6,869,404) and the like. Another such sensor may be an externally applied, wearable sensor, such as an ECG sensor, acoustic sensor, cuff blood pressure sensor, pulse oximeter, bio-impedance sensor and the like. Another such sensor may be an implantable or wearable glucose meter. Another such sensor may be an assay device, such as blood sugar analyzer, body fluid assay device, DNA chip, or chemical sensor.

The remote sensor(s) 112 may interface to the drug dispensing system in a variety of manners. By way of non-limiting example, in one embodiment, one or more sensors may be hard-wired 114 to the drug dispensing system using a digital or analog interface, as is known in the art. Alternatively or additionally, the drug dispensing system and one or more sensors may share a multi-modal wired or wireless digital network, such as an Ethernet link, Bluetooth network or the Internet. Alternatively or additionally, one or more sensors communicate with the drug dispensing system via a wireless RF, inductive, electrical (e.g., an electrical body bus as disclosed and described in U.S. Pat. No. 5,796,827), optical, infrared, or acoustic (as e.g., as disclosed and described in U.S. Pat. No. 7,024,248 link 116. The system may incorporate antennae and transducers to affect said wireless link, or may be linked to transceivers which are external to the system itself. In some embodiments, readings from one or more sensors are conveyed to the drug dispensing system using a removable digital media, such as magnetic media, flash disk, or memory card. In other embodiments, readings from one or more sensors may be read off a sensor display and entered manually into the system using a data input device.

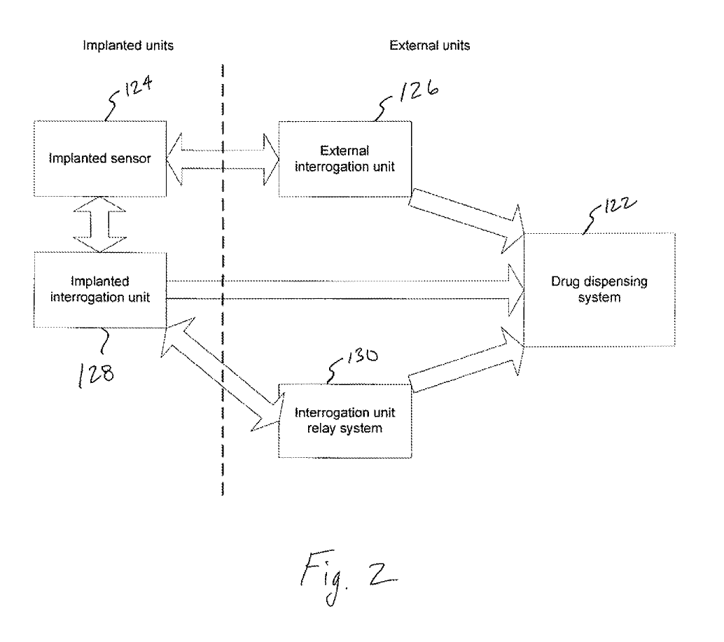

FIG. 2 shows another embodiment of the invention, comprising of an indirect link set-up between the drug dispensing system 122 and an implanted sensor 124. With this setup, the implanted sensor 124 communicates with an independent external interrogaiton unit 126 (e.g., as disclosed in U.S. Pat. No. 7,024,248), or with an implanted interrogation unit 128 (e.g., as disclosed in U.S. Pat. Appl. 20040204744), which in turn relay the sensor data to the drug dispensing system 122. The information relayed to the drug delivery system may be the raw sensor data, a processed version thereof (e.g. including calibration, smoothing, or other signal processing related steps), or any other signals, which at least partly depend on the sensor data.

Other embodiments may include additional relay devices along the way. In one example, also depicted in FIG. 2, an implanted sensor 124 communicates with an implanted interrogator 128, for example using an acoustic communication link. The implanted interrogator 128 may be integrated with an implant that performs an additional diagnostic or therapeutic functionality, such as a pacemaker, and communicates via an RF or inductive link to an external programmer 130. The programmer, in turn, relays the sensor information to the drug dispensing system.

In yet another embodiment, an interrogator may communicate using a wired or wireless link to a patient bedside unit, which may include processing means (“bedside controller”). The drug delivery system 122, in turn, communicates with the bedside controller to obtain implanted sensor-related data. In another embodiment, the bedside controller may connect to a remote server via the internet. The remote server can then pass the information to the drug dispensing system via an internet link.

Central Processor and Remote Server

With reference again to FIG. 1, the central processor 108 controls the drug dispensing system, and may be implemented in an embedded microcontroller responsible for coordinating the operation of the subsystems of the dispenser, including implementing the dispensing algorithm according to the physiological input received from the sensors and/or the UI. The microcontroller can be implemented in any of a myriad of ways known in the art.

In one embodiment, the controller is located externally to a body of the drug dispenser. For example, the controller 108 may be a personal computer or PDA that is in communication with the drug dispenser via a digital link, wherein the dispensing algorithm, UI, and communication functionality of the drug dispensing system could be implemented as a software program running on the computer or PDA.

The central processor may be autonomous, determining the dosing regimen entirely according to its preprogrammed algorithms and the available physiological data. In some embodiments, the processor is in constant or occasional communication with a remote server 120, and modifies its operation according to data received from the remote server. In other embodiments, the drug regimen algorithm runs partially or entirely on the remote server 120. Usage of a remote server allows updating the parameters and algorithms of the drug dispensing system according to physician's decisions, for example to take into account new information concerning interactions between different drugs. Allowing the dispensing algorithm to run remotely can have advantages in a hospital department or nursing home environment, where centralized control of a number of systems serving different patients may be required.

The central processor 108 may communicate information to the remote server 120 concerning the clinical state of the patient, e.g., as determined from the available physiological data. This, in turn, may generate various medical alerts at the remote side. The central processor 108 may also communicate statistics concerning medication use, as well as current drug inventory, and may activate an alarm in case of misusage of drugs (e.g., such as wrong dosage, or non-compliance). The said alarm may be activated by any known means of communication to the physician and/or another caregiver and/or service center and/or patient's relatives. This system may also be linked at the remote side to inventory alerts and, by way of further examples, automatic activation of drug purchasing and/or delivery.

The central processor and remote server, if present, are preferably connected using a communication link 118, which may be wired or wireless. The communication link 118 may be a web link through an internet connection, a direct link through a landline or wireless telephone network, a wired or wireless local area network, a direct RF, optical or electrical connection, or any other linkage method known in the art.

What is claimed is:

1. An automatic drug dispensing system that dispenses variable amounts or types of drugs to treat a particular medical condition of a patient, the system comprising:
a medical sensor which may be implanted in or otherwise coupled to a body surface of a patient, wherein the sensor is configured to measure one or more physiological parameters of the patient;
a user interface configured for receiving input relating to the patient's current condition; and
a processor configured to determine one or more of a drug selection, dosage, and timing regime based at least in part on information received from the medical sensor and user interface.

2. The system of claim 1, wherein the dispenser is in remote communication with a computer situated at the location of a medical caregiver.

3. The system of claim 2, configured to allow the medical caregiver to monitor the activities of the drug dispensing system over the remote communication link.

4. The system of claim 2, configured to allow the medical caregiver to modify parameters controlling the activities of the drug dispensing system.

5. The system of claim 4, the parameters including a drug dispensing algorithm.
